(19) United States
(12) Patent Application Publication
(10) Pub. No.: US 2020/0204950 A1
(43) Pub. Date: Jun. 25, 2020

(54) METHOD FOR AUTOMATICALLY ADJUSTING SUPL PROTOCOL, AND STORAGE MEDIUM AND MOBILE TERMINAL

(71) Applicant: HUIZHOU TCL MOBILE COMMUNICATION CO., LTD., HUiZHOU (CN)

(72) Inventor: DAPENG WANG, HUIZHOU (CN)

(21) Appl. No.: 16/620,885

(22) PCT Filed: Jul. 23, 2018
(86) PCT No.: PCT/CN2018/096606

§ 371 Date: Dec. 10, 2019

(30) Foreign Application Priority Data
Jul. 21, 2017 (CN) 201710601983.8

(51) Int. Cl. H04W 4/02; H04L 1/24; H04L 12/24; H04L 29/06; H04W 64/00; H04W 80/08

(52) U.S. Cl. CPC H04W 4/023; H04L 1/244; H04L 41/0816; H04W 80/085; H04L 63/166; H04L 69/26; H04W 64/003; H04L 41/0876

(57) ABSTRACT

Disclosed are a method for automatically adjusting an SUPL protocol, and a storage medium and a mobile terminal. The method comprises the steps of: storing different versions of an SUPL protocol in a mobile terminal in advance, and when a change in an accessed auxiliary positioning server is detected, configuring an SUPL protocol, the version of which corresponds to the current auxiliary positioning server, for the mobile terminal. The problem in the prior art of an SUPL protocol configured for a mobile terminal being unable to automatically match different auxiliary positioning servers is solved.

### TECHNICAL FIELD

The present disclosure relates to the field of automatically positioning technologies, and in particular, to a method for automatically adjusting an SUPL protocol, a storage medium, and a mobile terminal.

### BACKGROUND

At present, most mobile terminals have a positioning function, and their AGNSS auxiliary positioning function also make positioning effect of the mobile terminals become faster and more power-saving. A service positioning function of a mobile terminal must depend on auxiliary positioning data provided thereto by a server, however, operators in different regions may choose different auxiliary positioning servers, the different auxiliary positioning servers correspond to different SUPL protocols, that is, secure user plane locationing protocols, which are used to transmit auxiliary positioning data between mobile terminals and auxiliary positioning servers. A version of a SUPL protocol of a mobile terminal in the prior art is fixed, once an auxiliary positioning server changes, there may be inconsistence between a version of a SUPL protocol supported by the server and a version of a SUPL protocol configured for the mobile terminal, which results in that the auxiliary positioning function of the mobile terminal cannot work normally.

Therefore, the prior art still needs to be improved and developed.

### SUMMARY

In view of the defect of the above prior art, a purpose of the present disclosure is to provide a method for automatically adjusting an SUPL protocol, a storage medium, and a mobile terminal, which aim at solving the problem in the prior art that an SUPL protocol configured for a mobile terminal is unable to automatically match different auxiliary positioning servers.

Technical solutions of the present disclosure are as follows.

A method for automatically adjusting an SUPL protocol comprising these operations: storing different versions of SUPL protocols in a mobile terminal in advance; and when a change in an accessed auxiliary positioning server is detected, configuring an SUPL protocol of which the version corresponds to the current auxiliary positioning server for the mobile terminal.

The method for automatically adjusting an SUPL protocol, wherein, the operation of storing different versions of SUPL protocols in a mobile terminal in advance further comprises: setting a storage file storing corresponding relationships between auxiliary positioning servers and SUPL protocols in the mobile terminal in advance.

The method for automatically adjusting an SUPL protocol, wherein, the operation of when a change in an accessed auxiliary positioning server is detected, configuring an SUPL protocol of which the version corresponds to the current auxiliary positioning server for the mobile terminal specifically comprises: detecting whether the accessed auxiliary positioning server is changed; if the accessed auxiliary positioning server is changed, determining whether a version of an SUPL protocol currently configured for the mobile terminal and a version of an SUPL protocol corresponding to a current auxiliary positioning server are the same; if they are the same, ending the process; if they are different, switching an SUPL protocol of the mobile terminal to the SUPL protocol of which the version corresponds to the current auxiliary positioning server.

The method for automatically adjusting an SUPL protocol, wherein, the operation of determining whether a version of an SUPL protocol currently configured for the mobile terminal and a version of an SUPL protocol corresponding to a current auxiliary positioning server are the same specifically comprises: searching a version of an SUPL protocol corresponding to a current auxiliary positioning server; acquiring a version of an SUPL protocol currently configured for the mobile terminal; and determining whether the version of the SUPL protocol corresponding to the current auxiliary positioning server and the version of the SUPL protocol currently configured for the mobile terminal are the same.

The method for automatically adjusting an SUPL protocol, wherein, in the operation of searching a version of an SUPL protocol corresponding to a current auxiliary positioning server, the version of the SUPL protocol corresponding to the current auxiliary positioning server is searched in the storage file.

The method for automatically adjusting an SUPL protocol, wherein, the storage file is further configured to store SUPL protocol version information of the mobile terminal after switching.

The method for automatically adjusting an SUPL protocol, wherein, after the operation of if they are different, switching an SUPL protocol of the mobile terminal to the SUPL protocol of which the version corresponds to the current auxiliary positioning server, the method further comprises: updating the SUPL protocol version information of the mobile terminal after switching in the storage file.

A storage medium, which stores a plurality of instructions; wherein, the instructions are suitable for a processor to load and execute the method for automatically adjusting an SUPL protocol according to any one of the above.

A mobile terminal, which comprises: a processor being suitable for implementing instructions; and a storage medium being suitable for storing a plurality of instructions, wherein the instructions are suitable for the processor to load and execute the method for automatically adjusting an SUPL protocol according to any one of the above.

Beneficial effects: in the present disclosure, by storing different versions of SUPL protocols in advance in a mobile terminal, and according to the difference of the auxiliary positioning server accessed by the mobile terminal, selecting an SUPL protocol of which the version corresponds to the auxiliary positioning server to reconfigure the mobile terminal, it is achieved that the SUPL protocol configured for the mobile terminal can automatically match with the accessed auxiliary positioning server, and the problem in the prior art that an SUPL protocol configured for a mobile terminal is unable to automatically match with different auxiliary positioning servers is solved.

### BRIEF DESCRIPTION OF THE DRAWINGS

FIG. 1 is a flow chart of a preferred embodiment of a method for automatically adjusting an SUPL protocol of the present disclosure.

### DETAILED DESCRIPTION

The present disclosure provides a method for automatically adjusting an SUPL protocol, a storage medium, and a mobile terminal. In order to make purposes, technical solutions, and effects of the present disclosure be clearer and more explicit, the present disclosure is further described in detail below. It should be understood that the specific embodiments described here are only intended to illustrate the present disclosure, but not to limit the present disclosure.

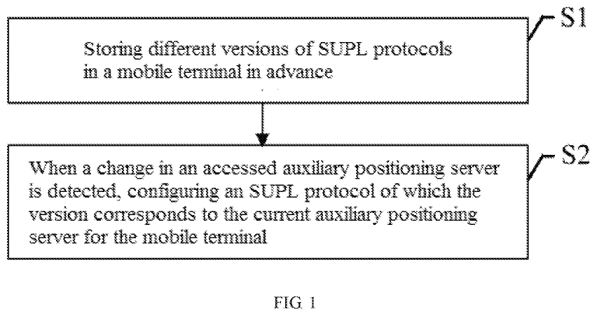

A method for automatically adjusting an SUPL protocol, as shown in FIG. 1, comprises the following operations: S1, storing different versions of SUPL protocols in a mobile terminal in advance; and S2, when a change in an accessed auxiliary positioning server is detected, configuring an SUPL protocol of which the version corresponds to the current auxiliary positioning server for the mobile terminal.

Since in the prior art, a version of an SUPL protocol of a mobile terminal is fixed, once an accessed auxiliary positioning server is changed because of reasons such as different regions, different networks, or the like, a version of an SUPL protocol supported by a new auxiliary positioning server may be inconsistent with a version of an SUPL protocol configured for the mobile terminal. However, in the present disclosure, different versions of SUPL protocols are stored in a mobile terminal in advance; when a change in an auxiliary positioning server accessed by the mobile terminal is detected, the mobile terminal changes the currently configured SUPL protocol, and configures it into a version that can be supported by a newly accessed auxiliary positioning server (i.e., a corresponding version), such that a version of an SUPL protocol supported by a new auxiliary positioning server can be consistent with a version of an SUPL protocol configured for the mobile terminal, and it is ensured that an auxiliary positioning function of the mobile terminal is normal.

When the region position where the mobile terminal is located or the accessed network is changed, the mobile terminal will select the most suitable auxiliary positioning server according to the newly accessed network or the region position.

When the mobile terminal detects a change of the accessed auxiliary positioning server, it automatically searches a version of an SUPL protocol supported by a currently accessed new auxiliary positioning server. Since in the operation S1, different versions of SUPL protocols have already been stored in the mobile terminal, it is possible to directly select a version supported by the current auxiliary positioning server from the stored SUPL protocols to configure for the mobile terminal.

Preferably, the operation S1 further comprises: setting a storage file storing corresponding relationships between auxiliary positioning servers and SUPL protocols in the mobile terminal in advance. Specifically, relationships between characteristics information of auxiliary positioning servers and versions of SUPL protocols can be stored; through the storage file, an SUPL version supported by a current auxiliary positioning server can quickly searched; further, according to the searching result, the version supported by the current auxiliary positioning server is selected from the stored SUPL protocols to configure for the mobile terminal.

The operation S2 specifically comprises: S21, detecting whether the accessed auxiliary positioning server is changed; if yes, entering an operation S22; S22, determining whether a version of an SUPL protocol currently configured for the mobile terminal and a version of an SUPL protocol corresponding to a current auxiliary positioning server are the same; if they are the same, ending the process; otherwise, entering an operation S23; and S23, configuring an SUPL protocol of the mobile terminal into a version corresponding to the current auxiliary positioning server.

In the operation S2, whether the auxiliary positioning server accessed by the mobile terminal is changed is monitored in real time or regularly. Once it is detected that the auxiliary positioning server is changed, a version of an SUPL protocol supported by the changed auxiliary positioning server is very likely to be different from a version of an SUPL protocol supported by the auxiliary positioning server before being changed, that is, the version of the SUPL protocol supported by the changed auxiliary positioning server is inconsistent with the version of the SUPL protocol currently configured for the mobile terminal, and a positioning function of the mobile terminal is affected. Therefore, it is required to determine whether to change the SUPL protocol configured for the mobile terminal according to the specific condition of the SUPL protocol currently configured for the mobile terminal, that is, execute the operation S22; when no change of the auxiliary positioning server is detected, the version of the SUPL protocol supported by the current auxiliary positioning server is inevitably consistent with the version of the SUPL protocol currently configured for the mobile terminal, and it is not required to execute any other change operation.

In the operation S22, since versions of SUPL protocols supported by different auxiliary positioning servers may be the same, although the auxiliary positioning server accessed by the mobile terminal may be changed, the version of the SUPL protocol supported by the server may be the same as the version of the SUPL protocol supported by the auxiliary positioning server before being changed, that is, the same as the version of the SUPL protocol currently configured for the mobile terminal (in other words, the SUPL protocol configured for the mobile terminal still can match with the changed auxiliary positioning server). Therefore, after detecting that the auxiliary positioning server accessed by the mobile terminal is changed, whether the version of the SUPL protocol currently configured for the mobile terminal and the version of the SUPL protocol corresponding to the current auxiliary positioning server are the same should be first determined; if they are the same, the process is directly ended, so as to avoid repeatedly configuring SUPL protocols in the same version; if the version of the SUPL protocol currently configured for the mobile terminal is different from the version of the SUPL protocol corresponding to the current auxiliary positioning server, in other words, the version of the SUPL protocol currently configured for the mobile terminal is not a version of an SUPL protocol supported by the current auxiliary positioning server, the SUPL protocol configured for the mobile terminal is reconfigured, that is, entering the operation S23.

Specifically, the operation S22 comprises: S221, searching a version of an SUPL protocol corresponding to a current auxiliary positioning server; S222, acquiring a version of an SUPL protocol currently configured for the mobile terminal; and S223, determining whether the version of the SUPL protocol corresponding to the current auxiliary positioning server and the version of the SUPL protocol currently configured for the mobile terminal are the same; if they are the same, ending the process; otherwise, executing the operation S23.

In the operation S221, specifically, characteristics information of the current auxiliary positioning server is first acquired, and then the corresponding SUPL protocol version is searched in the aforesaid storage file according to the acquired characteristics information, that is, the version of the SUPL protocol supported by the current auxiliary positioning server is acquired.

In the operation S222, the version information of the SUPL protocol currently configured for the mobile terminal is acquired, so as to determine whether the version of the SUPL protocol currently configured by the mobile terminal and the version of the SUPL protocol supported by the currently accessed auxiliary positioning server are the same.

Preferably, the version information of the SUPL protocol after being switched by the mobile terminal is stored, and in particular, can be stored in the storage file, so as to acquire the version information of the SUPL protocol currently configured for the mobile terminal at the same time of searching the SUPL protocol version corresponding to the current auxiliary positioning server, and thereby reduce the time for searching.

In the operation S223, according to the version of the SUPL protocol corresponding to the current auxiliary positioning server acquired in the operation S221, and the version of the SUPL protocol currently configured for the mobile terminal acquired in the operation S222, whether the version information of the two versions are the same is compared; if they are the same, it is indicated that the SUPL protocol currently configured for the mobile terminal is a version that can be supported by the current auxiliary positioning server, and thus it is not required to change or reconfigure, the process can be ended; if the version information of the two versions are different, it is indicated that the SUPL protocol currently configured for the mobile terminal is not a version that can be supported by the current auxiliary positioning server, and thus it is required to reconfigure so as to ensure that a positioning function of the mobile terminal can be used normally.

S23, the SUPL protocol of the mobile terminal is configured into a version corresponding to the current auxiliary positioning server.

In the operation S23, according to searched SUPL protocol version information corresponding to the current auxiliary positioning server, an SUPL protocol supported by the current auxiliary positioning server is selected to reconfigure the mobile terminal.

At the same time, after the configuration for the SUPL protocol has been completed, the SUPL protocol version information of the mobile terminal after being switched is updated in the storage file, so that the SUPL protocol version of the mobile terminal after being switched can be quickly acquired at the next time.

In the present disclosure, the mobile terminal can be a mobile phone, a tablet computer, other mobile terminal electronic devices, or the like.

Based on the above method, the present disclosure further provides storage medium, which stores a plurality of instructions; wherein, the instructions are suitable for a processor to load and execute the method for automatically adjusting an SUPL protocol according to any one of the above.

Based on the above method, the present disclosure further provides a mobile terminal, which comprises: a processor being suitable for implementing instructions, and a storage medium being suitable for storing a plurality of instructions, wherein the instructions are suitable for the processor to load and execute the method for automatically adjusting an SUPL protocol according to any one of the above.

Technical details and advantages of the mobile terminal and the storage medium have already described in detail in the above method, and are not repeated here.

In conclusion, in the present disclosure, by storing different versions of SUPL protocols in advance in a mobile terminal, and according to the difference of the auxiliary positioning server accessed by the mobile terminal, selecting an SUPL protocol of which the version corresponds to the auxiliary positioning server to reconfigure the mobile terminal, it is achieved that the SUPL protocol configured for the mobile terminal can automatically match with the accessed auxiliary positioning server, and the problem in the prior art that an SUPL protocol configured for a mobile terminal is unable to automatically match with different auxiliary positioning servers is solved.

It should be understood that the application of the present disclosure is not limited to the above embodiments. For those skilled in the art, it is possible to make improvements and modifications according to the above description, and all of these improvements and modifications should belong to the protection scope of the appended claims of the present disclosure.

1. A mobile terminal, comprising:
a processor configured for implementing instructions; and
a storage medium configured for storing a plurality of instructions, wherein, the instructions are configured to be loaded by the processor to execute a method for automatically adjusting an SUPL protocol, and the method for automatically adjusting an SUPL protocol comprises the operations of: storing different versions of SUPL protocols and setting a storage file storing corresponding relationships between auxiliary positioning servers and SUPL protocol versions in the mobile terminal in advance; and when a change in an accessed auxiliary positioning server is detected, configuring an SUPL protocol of which the version corresponds to the current auxiliary positioning server for the mobile terminal.

2. The mobile terminal according to claim 1, wherein, the operation of when a change in an accessed auxiliary positioning server is detected, configuring an SUPL protocol of which the version corresponds to the current auxiliary positioning server for the mobile terminal comprises: detecting whether the accessed auxiliary positioning server is changed; if the accessed auxiliary positioning server is changed, determining whether a version of an SUPL protocol currently configured for the mobile terminal and a version of an SUPL protocol corresponding to a current auxiliary positioning server are the same; if the two versions are the same, ending the process; if the two versions are different, switching an SUPL protocol of the mobile terminal to the SUPL protocol of which the version corresponds to the current auxiliary positioning server.

3. The mobile terminal according to claim 2, wherein, the operation of determining whether a version of an SUPL protocol currently configured for the mobile terminal and a version of an SUPL protocol corresponding to a current auxiliary positioning server are the same comprises: searching a version of an SUPL protocol corresponding to a current auxiliary positioning server; acquiring a version of an SUPL protocol currently configured for the mobile terminal; and determining whether the version of the SUPL protocol corresponding to the current auxiliary positioning server and the version of the SUPL protocol currently configured for the mobile terminal are the same.

4. The mobile terminal according to claim 3, wherein, in the operation of searching a version of an SUPL protocol corresponding to a current auxiliary positioning server, the version of the SUPL protocol corresponding to the current auxiliary positioning server is searched in the storage file.

5. The mobile terminal according to claim 2, wherein, the storage file is further configured to store SUPL protocol version information of the mobile terminal after switching.

6. The mobile terminal according to claim 5, wherein, after the operation of if the two versions are different, switching an SUPL protocol of the mobile terminal to the SUPL protocol of which the version corresponds to the current auxiliary positioning server, the method further comprises: updating the SUPL protocol version information of the mobile terminal after switching in the storage file.

7. A method for automatically adjusting an SUPL protocol, comprising the operations of: storing different versions of SUPL protocols in a mobile terminal in advance; and when a change in an accessed auxiliary positioning server is detected, configuring an SUPL protocol of which the version corresponds to the current auxiliary positioning server for the mobile terminal.

8. The method for automatically adjusting an SUPL protocol according to claim 7, wherein, the operation of storing different versions of SUPL protocols in a mobile terminal in advance further comprises: setting a storage file storing corresponding relationships between auxiliary positioning servers and SUPL protocol versions in the mobile terminal in advance.

9. The method for automatically adjusting an SUPL protocol according to claim 8, wherein, the operation of when a change in an accessed auxiliary positioning server is detected, configuring an SUPL protocol of which the version corresponds to the current auxiliary positioning server for the mobile terminal comprises: detecting whether the accessed auxiliary positioning server is changed; if the accessed auxiliary positioning server is changed, determining whether a version of an SUPL protocol currently configured for the mobile terminal and a version of an SUPL protocol corresponding to a current auxiliary positioning server are the same; if the two versions are the same, ending the process; if the two versions are different, switching an SUPL protocol of the mobile terminal to the SUPL protocol of which the version corresponds to the current auxiliary positioning server.

10. The method for automatically adjusting an SUPL protocol according to claim 9, wherein, the operation of determining whether a version of an SUPL protocol currently configured for the mobile terminal and a version of an SUPL protocol corresponding to a current auxiliary positioning server are the same comprises: searching a version of an SUPL protocol corresponding to a current auxiliary positioning server; acquiring a version of an SUPL protocol currently configured for the mobile terminal; and determining whether the version of the SUPL protocol corresponding to the current auxiliary positioning server and the version of the SUPL protocol currently configured for the mobile terminal are the same.

11. The method for automatically adjusting an SUPL protocol according to claim 10, wherein, in the operation of searching a version of an SUPL protocol corresponding to a current auxiliary positioning server, the version of the SUPL protocol corresponding to the current auxiliary positioning server is searched in the storage file.

12. The method for automatically adjusting an SUPL protocol according to claim 9, wherein, the storage file is further configured to store SUPL protocol version information of the mobile terminal after switching.

13. The method for automatically adjusting an SUPL protocol according to claim 12, wherein, after the operation of if the two versions are different, switching an SUPL protocol of the mobile terminal to the SUPL protocol of which the version corresponds to the current auxiliary positioning server, the method further comprises: updating the SUPL protocol version information of the mobile terminal after switching in the storage file.

14. A storage medium, which stores a plurality of instructions; wherein, the instructions are configured to be loaded by a processor to execute a method for automatically adjusting an SUPL protocol, and the method for automatically adjusting an SUPL protocol comprises the operations of: storing different versions of SUPL protocols in a mobile terminal in advance; and when a change in an accessed auxiliary positioning server is detected, configuring an SUPL protocol of which the version corresponds to the current auxiliary positioning server for the mobile terminal.

15. The storage medium according to claim 14, wherein, the operation of storing different versions of SUPL protocols in a mobile terminal in advance further comprises: setting a storage file storing corresponding relationships between auxiliary positioning servers and SUPL protocol versions in the mobile terminal in advance.

16. The storage medium according to claim 15, wherein, the operation of when a change in an accessed auxiliary positioning server is detected, configuring an SUPL protocol of which the version corresponds to the current auxiliary positioning server for the mobile terminal comprises: detecting whether the accessed auxiliary positioning server is changed; if the accessed auxiliary positioning server is changed, determining whether a version of an SUPL protocol currently configured for the mobile terminal and a version of an SUPL protocol corresponding to a current auxiliary positioning server are the same; if the two versions are the same, ending the process; if the two versions are different, switching an SUPL protocol of the mobile terminal to the SUPL protocol of which the version corresponds to the current auxiliary positioning server.

17. The storage medium according to claim 16, wherein, the operation of determining whether a version of an SUPL protocol currently configured for the mobile terminal and a version of an SUPL protocol corresponding to a current auxiliary positioning server are the same comprises: searching a version of an SUPL protocol corresponding to a current auxiliary positioning server; acquiring a version of an SUPL protocol currently configured for the mobile terminal; and determining whether the version of the SUPL protocol corresponding to the current auxiliary positioning server and the version of the SUPL protocol currently configured for the mobile terminal are the same.

18. The storage medium according to claim 17, wherein, in the operation of searching a version of an SUPL protocol corresponding to a current auxiliary positioning server, the version of the SUPL protocol corresponding to the current auxiliary positioning server is searched in the storage file.

19. The storage medium according to claim 16, wherein, the storage file is further configured to store SUPL protocol version information of the mobile terminal after switching.

20. The storage medium according to claim 19, wherein, after the operation of if the two versions are different, switching an SUPL protocol of the mobile terminal to the SUPL protocol of which the version corresponds to the current auxiliary positioning server, the method further comprises: updating the SUPL protocol version information of the mobile terminal after switching in the storage file.
